(19) United States
(12) Patent Application Publication
(10) Pub. No.: US 2006/0234030 A1
(43) Pub. Date: Oct. 19, 2006

(54) Belowgrade damp proofing and waterproofing with thermoplastic polyurethane (TPU)

(76) Inventors: James Thompson-Colon, Moon Township, PA (US); Timothy J. Jacobs, Emsworth, PA (US); Walter E. Heckla, Pittsburgh, PA (US); George Niu Ong, Coraopolis, PA (US); Michael A. Blaszkiewicz, Gibsonia, PA (US)

Correspondence Address: BAYER MATERIAL SCIENCE LLC, 100 BAYER ROAD, PITTSBURGH, PA, 15205, US

(21) Appl. No.: 11/357,579

(22) Filed: Feb. 17, 2006

Related U.S. Application Data
(63) Continuation-in-part of application No. 11/106,937, filed on Apr. 15, 2005.

(51) Int. Cl. B32B 3/26

(52) U.S. Cl. 428/304.4

(57) ABSTRACT

The present invention provides processes for damp proofing and waterproofing structures by the adhesion of a thin thermoplastic polyurethane (TPU) membrane to a belowgrade surface structure. The inventive processes may find application in the damp proofing and waterproofing of belowgrade structures such as building foundations and basements, reservoirs, ornamental pools, ponds, plaza decks, parking decks, walkways, tunnels, earthen shelters, bridge abutments, retaining walls, landfills and water/chemical canals, and may greatly reduce or even prevent the ingress of water and the concomitant entry of waterborne molds, fungi, salts and other pollutants such as pesticides and radon into those structures.

This application is a Continuation-in-Part, and claims the benefit, of U.S. Ser. No. 11/106,937 which was filed on Apr. 15, 2005.

### FIELD OF THE INVENTION

The present invention relates, in general, to structural construction and preservation, and more specifically, to processes for damp proofing and waterproofing belowgrade structures involving the adhesion of a thin thermoplastic polyurethane (TPU) membrane to the structure.

### BACKGROUND OF THE INVENTION

The entry of water into concrete structures can have major consequences to the interior of the structure. Molds, fungi, salts, pollutants (pesticides and radon) may enter the structure, carried along by the water. After the water evaporates, these undesirable materials are left behind to accumulate inside the structure and affect the internal environment. There are two types of techniques used to reduce water ingress in building foundations; the less effective of these is damp proofing with the ultimate procedure being waterproofing.

Most building codes in the U.S. describe a damp proofing membrane as a preparation (i.e., a coating) that is applied to the exterior surface of foundation walls in areas which are not expected to be subject to hydrostatic pressures due to soil moisture conditions. This coating separates usable living space from exterior belowground conditions and acts as a capillary break to stop the movement (migration) of liquid moisture in the soils from coming into direct contact with the exterior face of a foundation wall system. Thus, damp proofing prevents water vapor and/or minor amounts of moisture from penetrating into a structure. In addition, damp proofing materials are not subject to appreciable weathering or water pressure.

Waterproofing systems prevent water intrusion into the structure. Waterproofing materials may also serve as a barrier to different pollutants. Waterproofing membranes are defined in most U.S. building codes as a preparation (coating/barrier) that is applied to the exterior surface of the foundation walls in areas that are known, or are expected, to be subject to hydrostatic pressures due to soil moistures conditions. Like damp proofing, waterproofing separates usable living space in basements from exterior below ground conditions.

The available approaches to waterproofing include the use of bentonite clay, liquid applied membranes, built-up bituminous membranes, prefabricated sheets and cementitious or crystalline coatings.

Bentonite clay (sodium bentonite) has the advantages of being safe to work with, non-polluting, easy and quick to apply at low temperatures (˜25° F.) and does not require a primer or adhesive. However, the use of this absorptive and colloidal clay has some disadvantages, it requires proper confinement for maximum performance, the clay should be protected from water prior to installation and uncertainty is associated with bentonite because the integrity of the seal cannot be checked prior to backfilling the foundation and water reaching the bentonite material.

Liquid applied membranes (LAM) have the advantages of low cost, being quick to apply, having excellent crack-bridging capabilities and some of the emulsions may be applied on green concrete. Liquid applied membranes suffer from the following disadvantages: there is a possibility of inconsistency in coverage, the materials are toxic and flammable, all of the materials cannot be used on green concrete, the emulsion can be washed off by rain and the LAM cannot be exposed to ultraviolet (UV) light.

Sheet membranes have a number of advantages over the above-described materials. Sheet membranes have a high water pressure resistance, are of a consistent thickness, provide for an easy repair of installation faults and possess crack-bridging capabilities. Thus, a number of patents describe materials and processes for damp proofing and waterproofing belowground structures using sheet materials.

Haage, et al., in U.S. Pat. No. 4,239,795, provide a protective covering for the protection of surface seals against mechanical damage in building constructions and other civil engineering constructions which comprises a composite of an elastic, waterproof thermoplastic synthetic resin film sheet and/or synthetic resin layer and a lattice-like fabric having knot couplings or points of intersection of the threads that yield under the effect of a load.

U.S. Pat. No. 4,589,804, issued to Paeglis, et al. describes a waterproof membrane comprising an elastomeric sheet which is formed of a composition including a neutralized acid group containing elastomeric polymer, the neutralized acid group cation selected from the group consisting of ammonium, antimony, aluminum, iron, lead and a metal of Group IA, IIA, IB or IIB of the Periodic Table of Elements and mixtures thereof; a non-polar process oil; carbon black and a preferential plasticizer. In a preferred embodiment the membrane is supported with a supporting sheet selected from the group consisting of fabrics, paper and metal foil. The use of this membrane as a roof covering, pond, pit or aqueduct liner is recited.

Villarreal, in U.S. Pat. No. 4,693,042, discloses a system of flood protection for buildings. This system is made of a lower skirt of plastic film secured by a waterproof seal to the building foundation, an upper skirt of plastic film secured to an upper level of the building above the maximum projected rise of flood waters, and side skirts secured at each side of the upper and lower skirts. The skirts form adjoining continuous enclosures which are to extend completely around the building are to be of a size and shape permitting each skirt to be unfolded or unwound to meet the other. The edges of each skirt are to have waterproof seals, such as a zip-lock seal, for waterproof sealing to protect the building against rising waters.

U.S. Pat. No. 4,775,567, issued to Harkness, provides a waterproofing laminate said to be suitable for use in roofs, floors, or other surfaces where waterproofing is desired. The laminate of Harkness is made of an elastomeric sheet secured to a modified bitumen layer and a release sheet secured to the modified bitumen layer.

U.S. Pat. No. 5,271,781, issued to Anno, et al., discloses a waterproof sheet for concrete structures. The sheet is made of a thermoplastic synthetic resin, and powder of cement which is pressed against the sheet and adhered to one side surface or both side surfaces of the sheet. Anno, et al. also disclose a method of manufacturing a waterproof sheet for concrete structures and a method of applying a waterproof sheet to the concrete structure.

Bartlett, et al., in U.S. Pat. No. 5,316,848, provide a waterproofing membrane made of a carrier, a synthetic adhesive coated on one face of the carrier substrate, and a protective layer coated on the synthetic adhesive. The disclosure of Bartlett, et al. also provides a method of waterproofing post cast concrete structures involving adhering their waterproofing membrane to all or part of the exposed surface of the structure.

U.S. Pat. No. 5,481,838, issued to Fishel et al., teaches an anti-fracture, water-resistant, masonry-bondable membrane made of a lamina having a central layer generally containing at least one ply of a flexible material, e.g., an organic polymer such as polyvinyl chloride, generally in the form of a sheet, and a nonwoven fiber layer physically bonded to each side thereof. The formation of the lamina in the invention of Fishel et al. is accomplished by laminating a single, nonwoven layer to a layer or sheet of a flexible material in the presence of heat and pressure to produce a construction wherein the nonwoven fibers are partially embedded in the flexible material. Subsequently, two such constructions are bonded together under heat and pressure to produce essentially a four-ply lamina wherein the layers of flexible material such as a polymer are fused to one another. The flexible membrane lamina, when utilized between and bonded to an exterior masonry article such as ceramic tile and to a substrate such as concrete, is said to be very effective in preventing any cracks from propagating from the substrate to the article. The flexible membrane of Fishel et al. is also stated to have very good hydrostatic water resistance.

Oakley, in U.S. Pat. No. 6,224,700, discloses a method for waterproofing an architectural component involving application of a waterproofing composition to the component above a grade line to form an non-swelling elastomeric membrane having a tacky exterior and pressing a flexible, non-porous polymeric sheet onto the tacky exterior of the elastomeric membrane. Oakley prefers that his polymeric sheet be stronger than the elastomeric membrane to protect the elastomeric membrane from punctures or tears.

U.S. Pat. No. 6,586,080 issued to Heifetz teaches a two layered sealing sheet assembly bondable to a construction surface made of (a) an upper layer of a first substance, the upper layer being selected fluid impermeable; and (b) a lower flexible layer of a second substance, the lower flexible layer being bondable to the construction surface. The upper layer and the lower flexible layer are at least partially attached to one another.

Many of these damp proofing and waterproofing methods involve complicated, labor-intensive processes to apply the sometimes complex waterproofing or damp proofing material to the structure. Consequently, a need continues to exist in the art for simple, effective processes for damp proofing and waterproofing of belowground structures.

### SUMMARY OF THE INVENTION

Accordingly, the present invention provides such processes for damp proofing and waterproofing belowgrade structures involving the adhesion of a thin thermoplastic polyurethane (TPU) film or sheet to the structure. The inventive processes may find application in damp proofing and waterproofing of belowgrade structures such as building foundations and basements, reservoirs, ornamental pools, ponds, plaza decks, parking decks, walkways, tunnels, earthen shelters, bridge abutments, retaining walls, landfills, water/chemical canals, etc. The inventive processes greatly reduce or even prevent the ingress of water and therefore the concomitant entry of waterborne molds, fungi, salts and other pollutants such as pesticides and radon into those structures.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages and so forth in the specification are to be understood as being modified in all instances by the term “about.”

The present invention provides a damp proofing process involving adhering to a belowgrade surface of a structure a thermoplastic polyurethane (TPU) membrane having a thickness of from 0.0508 mm (0.002 in.) to 0.457 mm (0.018 in.).

The present invention further provides a waterproofing process involving adhering to a belowgrade surface of a structure a thermoplastic polyurethane (TPU) membrane having a thickness of from 0.0508 mm (0.002 in.) to 0.457 mm (0.018 in.) and capable of withstanding a hydrostatic pressure of at least 138 kPa (20 psi).

The present invention still further provides a process for reducing ingress of at least one of water, radon, molds, fungi, salts and pesticides into a structure involving adhering to a belowgrade surface of the structure a thermoplastic polyurethane (TPU) membrane having a thickness of from 0.0508 mm (0.002 in.) to 0.457 mm (0.018 in.) and capable of withstanding a hydrostatic pressure of at least 138 kPa (20 psi).

Properties of the waterproofing materials described above in the Background section of the instant specification are compared to those of one of the thermoplastic polyurethane membranes used in the inventive processes in the table below.

| | | Use on | | | | |
|---|---|---|---|---|---|---|
| | Weight | green | | Tensile | Thickness | Resist. hydro. |
| Material | (lb/200 f²) | concrete | Elongation (%) | (psi) | (mils) | head (ft) |
| bentonite | 230 | yes | 100-700 | — | 150-200 | 150 |
| LAM | NA | some | 500-2000 | — | 60-200 | 64 |
| sheet | 80 | no | 300-850 | 5000 | 60-120 | 150-240 |
| membrane | | | | | | |
| TPU sheet | 12 | unknown | 600 | 9000 | 6 | 200 |

Membranes produced from any thermoplastic polyurethane resin may be used in the inventive processes. The membranes are preferably of the thickness of from 0.002 to 0.018 in. (i.e., 2 to 18 mils) (0.0508 mm to 0.457 mm), more preferably from 0.006 to 0.015 in. (0.152 mm to 0.381 mm) and most preferably 0.006 in. (0.152 mm). The thickness of the thermoplastic polyurethane membrane useful in the processes of the present invention may range between any combination of these values, inclusive of the recited values.

As is known to those skilled in the art, thermoplastic polyurethane resins are the reaction product of a diisocyanate, a chain extender (a short chain diol) and a polyol. Catalysts can additionally be added to accelerate the formation reaction.

Preferred polyols for producing the thermoplastic polyurethane resin include polyethers, polycarbonates and mixtures thereof.

Suitable polyether polyols may be prepared by reacting one or more alkylene oxides having from 2 to 4 carbon atoms in the alkylene radical with a starter molecule containing two active hydrogen atoms bonded therein. Examples of alkylene oxides inicude ethylene oxide, 1,2-propylene oxide, epichlorohydrin and 1,2- and 2,3-butylene oxide. The alkylene oxides may be used individually, alternately in succession, or in the form of mixtures. Starter molecules include, for example: water, amino alcohols, such as N-alkyldiethanolamines, for example N-methyl-diethanolamine, and diols, such as ethylene glycol, 1,3-propylene glycol, 1,4-butanediol and 1,6-hexanediol. It is also possible to use mixtures of starter molecules. Suitable polyether polyols are also the hydroxyl-group-containing polymerization products of tetrahydrofuran.

It is also possible to use trifunctional polyether polyols in amounts of from 0 to 30 wt. %, based on the bifunctional polyether polyols.

The substantially linear polyether polyols preferably have molecular weights of from 600 to 5,000. They may be used either individually or in the form of mixtures with one another.

Among the suitable organic diisocyanates are aliphatic, cycloaliphatic, araliphatic, heterocyclic and aromatic diisocyanates, such as described, for example, in Justus Liebigs Annalen der Chemie, 562, pages 75 to 136.

The following may be mentioned as specific examples: aliphatic diisocyanates, such as hexamethylene diisocyanate, cycloaliphatic diisocyanates, such as isophorone diisocyanate, 1,4-cyclohexane diisocyanate, 1-methyl-2,4- and -2,6-cyclohexane diisocyanate and the corresponding isomeric mixtures, 4,4′-, 2,4′- and 2,2′-dicyclohexylmethane diisocyanate and the corresponding isomeric mixtures, and, preferably, aromatic diisocyanates, such as 2,4-toluylene diisocyanate, mixtures of 2,4- and 2,6-toluylene diisocyanate, 4,4′-, 2,4′- and 2,2′-diphenylmethane diisocyanate, mixtures of 2,4′- and 4,4′-diphenylmethane diisocyanate, urethane-modified liquid 4,4′- and/or 2,4′-diphenylmethane diisocyanates, 4,4′-diisocyanatodiphenylethane-(1,2) and 1,5-naphthylene diisocyanate. Preference is given to the use of 1,6-hexamethylene diisocyanate, isophorone diisocyanate, dicyclohexylmethane diisocyanate, diphenylmethane diisocyanate isomeric mixtures having a 4,4′-diphenylmethane diisocyanate content of greater than 96 wt. %, and especially 4,4′-diphenylmethane diisocyanate and 1,5-naphthylene diisocyanate.

The mentioned diisocyanates may be used together with a polyisocyanate in an amount of up to 15% (based on diisocyanate), but at most in an amount such that an uncrosslinked product forms. Examples are triphenylmethane 4,4′,4″-triisocyanate and polyphenyl-polymethylene polyisocyanates.

The chain-lengthening agents are difunctional and/or trifunctional compounds having molecular weights of from 62 to 500 preferably aliphatic diols having from 2 to 14 carbon atoms, such as, for example, ethanediol, 1,6-hexanediol, diethylene glycol, dipropylene glycol and, especially, 1,4-butanediol. Also suitable, however, are diesters of terephthalic acid with glycols having from 2 to 4 carbon atoms, such as, for example, terephthalic acid bis-ethylene glycol or 1,4-butanediol, hydroxy alkylene ethers of hydroquinone, such as, for example, 1,4-di(β-hydroxyethyl)-hydroquinone, (cyclo)aliphatic diamines, such as, for example, isophorone-diamine, ethylenediamine, 1,2-, 1,3-propylene-diamine, N-methyl-1,3-propylene-diamine, N,N′-dimethyl-ethylene-diamine, aromatic diamines, such as, for example, 2,4- and 2,6-toluylene-diamine, 3,5-diethyl-2,4- and/or -2,6-toluylene-diamine, and primary ortho-di-, tri- and/or tetra-alkyl-substituted 4,4′-diaminodiphenyl-methanes. It is also possible to use mixtures of the above-mentioned chain-lengthening agents.

For the preparation of the TPUs, the chain-extension components are reacted, optionally in the presence of catalysts, auxiliary substances and/or additives, in such amounts that the equivalence ratio of NCO groups to the sum of all the NCO-reactive groups, especially of the OH groups of the low molecular weight diols/triols and polyols, is from 0.9:1.0 to 1.2:1.0, preferably from 0.95:1.0 to 1.10:1.0.

Suitable catalysts, which accelerate the reaction between the NCO groups of the diisocyanates and the hydroxyl groups of the diol components, are those tertiary amines known in the art such as triethylamine, dimethylcyclohexylamine, N-methylmorpholine, N,N′-dimethyl-piperazine, 2-(dimethylaminoethoxy)-ethanol, diazabicyclo-(2,2,2)-octane and the like, as well as, organometallic compounds such as titanic acid esters, iron compounds, tin compounds, such as tin diacetate, tin dioctate, tin dilaurate or the tindialkyl salts of aliphatic carboxylic acids, such as dibutyltin diacetate, dibutyltin dilaurate and the like. The catalysts are preferably used in amounts of from 0.0005 to 0.1 part per 100 parts of polyhydroxy compound.

In addition to catalysts, auxiliary substances and/or additives may also be incorporated into the chain-extension components. Examples are lubricants, antiblocking agents, inhibitors, stabilizers against hydrolysis, light, heat and discoloration, flameproofing agents, colorings, pigments, inorganic and/or organic fillers and reinforcing agents.

Further components that may be incorporated into the TPU are thermoplastics such as polycarbonates and acrylonitrile-butadiene-styrene terpolymers, particularly ABS. Other elastomers, such as rubber, ethylene-vinyl acetate polymers, styrene-butadiene copolymers and other TPUs, may likewise be useful. Also suitable for incorporation are commercially available plasticizers such as, for example, phosphates, phthalates, adipates, sebacates.

The hydrostatic resistance of the thermoplastic membranes useful in the inventive waterproofing process is preferably at least 20 psi (138 kPa), more preferably at least 40 psi (276 kPa) and most preferably at least 90 psi (621 kPa). Thermoplastic polyurethane membranes, particularly those which are 0.002 in. (0.0508 mm), may optionally have a bituminous, bentonite or other coating applied to one side of the membrane.

Preferred as adhesive in the inventive processes are those adhesives which are known to those skilled in the art to be damp proof and/or waterproof. The adhesive may be pre-applied to the thermoplastic polyurethane membrane or may be applied to the belowgrade surface to be treated by the inventive processes prior to application of the membrane. A particularly preferred embodiment of the inventive process employs a “peel and stick” adhesive-backed thermoplastic polyurethane membrane which has the dual advantages of i) avoiding the production of harmful fumes and ii) removing the necessity of having to use machinery to apply the material. Another particularly preferred embodiment of the inventive process employs double sided adhesive tape to seal seams where the thermoplastic membranes meet or overlap.

Another embodiment of the waterproofing process of the present invention utilizes a water-swellable sheet to provide a “self-healing” or “self-sealing” membrane such that pin-sized holes would be sealed by the swelling. Among the possible ways of making TPU swellable are by using hydrophilic polyols (those having a high EO content), by incorporating ionic salts in the polymer matrix, and by mixing swellable clays into the TPU resin. Still another embodiment of the inventive process employs melt laminating the TPU on to a fleece to produce a fleece backed TPU sheet which would aid in the adherence of TPU to the belowgrade surface to be treated. The fleece may preferably be saturated with an adhesive (e.g., a polyurethane) and pressed against the surface.

### EXAMPLES

The present invention is further illustrated, but is not to be limited, by the following examples. The following materials were used in the examples:
TPU-A a commercially available thermoplastic membrane having a thickness of 0.006 in. (0.152 mm);
TPU-B a commercially available thermoplastic membrane having a thickness of 0.006 in. (0.152 mm);
TPU-C a commercially available thermoplastic membrane having a thickness of 0.010 in. (0.254 mm);
TPU-D a commercially available thermoplastic membrane having a thickness of 0.010 in. (0.254 mm);
TPU-E a commercially available thermoplastic membrane having a thickness of 0.015 in. (0.381 mm); and
TPU-F a commercially available thermoplastic membrane having a thickness of 0.002 in. (0.0508 mm)

The thermoplastic polyurethane (TPU) materials tested herein were subjected to hydrostatic pressure according to ASTM D-5385, “Standard Test Method for Hydrostatic Pressure Resistance of Waterproofing Membranes.”

Briefly, the test used an 8 in.×16 in.×2 in. (20.3 cm×40.6 cm×5.08 cm) concrete paver with a 0.125 in. (0.318 cm) kerf cut in the direction of the 16 in. (40.6 cm) to a depth of 1.75 in. (4.44 cm). The TPU membrane was cut into two pieces and glued to the concrete (uncut side) so that the two pieces of the membrane formed a 2 in. (5.08 cm) overlap. The adhesive was allowed to cure according to the manufacturer's instructions.

After the adhesive had cured, the cement paver was cracked by inserting a wedge in the kerf. The wedge, 0.25 in. (0.635 cm) thick, spread the kerf in the cement paver (when the sample was mounted into the fixture) and produced a crack on the surface to which the TPU membrane had been glued. The membrane along the crack was subsequently stretched.

The sample was mounted onto the fixture with the membrane facing towards the water cavity. The retainer plate was bolted and tightened. This tightening forced the concrete to align itself with the frame and retainer plate, opening the kerf to a 0.25 in. (0.635 cm) crack and thus stretching the membrane. After the tightening procedure, the water cavity was filled and air was applied to create hydrostatic pressure against the membrane. The pressure started at 15 psi (103 kPa) and was increased 15 psi (103 kPa) every hour until 90 psi (621 kPa) was achieved.

A failure results if the water leaks from the cavity. This leak is the result of either the membrane being unable to withstand the pressure or failure of the adhesive between the overlap. Table I below summarizes the results of these tests.

TABLE I

| Ex. | Membrane | | |
|---|---|---|---|
| No. | material | Mils | Result |
| 1 | TPU-A | 6 | Failed at overlap 45 psi (207 kPa) |
| 2 | TPU-B | 6 | Failed at overlap 45 psi (207 kPa) |
| 3 | TPU-C | 10 | Failed at overlap 45 psi (207 kPa) |
| 4 | TPU-D | 10 | Failed at overlap 45 psi (207 kPa) |
| 5 | TPU-E | 15 | Failed at overlap 45 psi (207 kPa) |
| 6 | TPU-F | 2 | Failed (no overlap) 30 psi (207 kPa)-pin |
| | | | hole |
| 7 | TPU-B | 6 | Held at 90 psi 621 kPa |

All of the thermoplastic polyurethane (TPU) materials in Examples 1-6, were capable of withstanding a hydrostatic pressure of 30 psi (207 kPa), but failed at the overlap area at the hydrostatic pressure as noted above in Table I. Although not wishing to be limited to any particular theory, the inventors herein speculate that a possible explanation for this failure could be the use of an incorrect type of adhesive. See Table II below for lists of the components in the adhesives used.

The thermoplastic membrane used in Example 7 was sealed at the overlap area with an automotive trim double-face tape (3M Acrylic Foam Tape (AFT) 5390).

TABLE II
Adhesives

| Adhesive Name (Manufacturer) | Listed Contents |
|---|---|
| SPRAY HIGH STRENGTH 90 (3M) | dimethyl ether, methyl acetate, |
| | cyclohexane, diflouroethane, |
| | pentane, methyl alcohol |
| SCOTCH WELD DP-8010 (3M) | methacrylate, |
| | acrylonitrile-butadiene-styrene |
| | resin, synthetic rubber oligomer, |
| | dibutyl itaconate, polyfunctional |
| | aziridine, amine borane complex |
| | and amorphous silica |
| ORIGINAL CONTACT CEMENT | petroleum naphtha, methyl ethyl |
| (DAP WELDWOOD) | ketone, toluene |
| ULTIMATE GLUE (ELMERS) | MDI pre-polymer |
| GOOP contact adhesive and | toluene and petroleum distillates |
| sealant (Eclectic Products) | |
| SUPER GLUE (Pacer Technology) | cyanoacrylate ester |

All of the TPU materials used in Examples 1-6 were retested without an overlap and passed at 90 psi (621 kPa) for one hour (data not shown).

The inventors herein contemplate that the inventive processes may find wide applicability in damp proofing and waterproofing such structures as building foundations, building basements, reservoirs, ornamental pools, ponds, plaza decks, parking decks, walkways, tunnels, earthen shelters, bridge abutments, retaining walls, landfills, chemical canals and water canals. In addition, the inventive processes may be helpful in reducing the levels of radon and other harmful environmental pollutants, pesticides, molds, fungi etc. in buildings by greatly reducing or preventing the ingress of water in which those contaminants are dissolved.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A damp proofing process comprising:
adhering to a belowgrade surface of a structure a thermoplastic polyurethane (TPU) membrane having a thickness of from about 0.0508 mm (0.002 in.) to about 0.457 mm (0.018 in.).

2. The process according to claim 1, wherein the thermoplastic polyurethane (TPU) membrane has a thickness of from about 0.152 mm (0.006 in.) to about 0.381 mm (0.015 in.).

3. The process according to claim 1, wherein the thermoplastic polyurethane (TPU) membrane has a thickness of about 0.152 mm (0.006 in.).

4. The process according to claim 1, wherein the thermoplastic polyurethane (TPU) membrane further includes an adhesive backing.

5. The process according to claim 1, wherein the thermoplastic polyurethane (TPU) membrane further includes a layer of fleece.

6. The process according to claim 1, wherein the belowgrade surface is one of concrete and masonry.

7. The process according to claim 1, wherein the structure is one of a building foundation, a building basement, a reservoir, an ornamental pool, a pond, a plaza deck, a parking deck, a walkway, a tunnel, an earthen shelter, a bridge abutment, a retaining wall, a landfill, a chemical canal and a water canal.

8. A waterproofing process comprising:
adhering to a belowgrade surface of a structure a thermoplastic polyurethane (TPU) membrane having a thickness of from about 0.0508 mm (0.002 in.) to about 0.457 mm (0.018 in.) and capable of withstanding a hydrostatic pressure of at least about 138 kPa (20 psi).

9. The process according to claim 8, wherein the thermoplastic polyurethane (TPU) membrane further includes a bituminous or bentonite coating.

10. The process according to claim 8, wherein the thermoplastic polyurethane (TPU) membrane has a thickness of from about 0.152 mm (0.006 in.) to about 0.381 mm (0.015 in.).

11. The process according to claim 8, wherein the thermoplastic polyurethane (TPU) membrane has a thickness of about 0.152 mm (0.006 in.).

12. The process according to claim 8, wherein the thermoplastic polyurethane (TPU) membrane further includes an adhesive backing.

13. The process according to claim 8, wherein the thermoplastic polyurethane (TPU) membrane further includes a layer of fleece.

14. The process according to claim 8, wherein the thermoplastic polyurethane (TPU) membrane is self-sealing.

15. The process according to claim 8, wherein the belowgrade surface is one of concrete and masonry.

16. The process according to claim 8, wherein the structure is one of a building foundation, a building basement, a reservoir, an ornamental pool, a pond, a plaza deck, a parking deck, a walkway, a tunnel, an earthen shelter, a bridge abutment, a retaining wall, a landfill, a chemical canal and a water canal.

17. The process according to claim 8, wherein the thermoplastic polyurethane (TPU) membrane is capable of withstanding a hydrostatic pressure of at least about 276 kPa (40 psi).

18. The process according to claim 8, wherein the thermoplastic polyurethane (TPU) membrane is capable of withstanding a hydrostatic pressure of at least about 621 kPa (90 psi).

19. A process for reducing ingress of at least one of water, radon, molds, fungi, salts and pesticides into a structure comprising:
adhering to a belowgrade surface of the structure a thermoplastic polyurethane (TPU) membrane having a thickness of from about 0.0508 mm (0.002 in.) to about 0.457 mm (0.018 in.) and capable of withstanding a hydrostatic pressure of at least about 138 kPa (20 psi).

20. The process according to claim 19, wherein the membrane comprises one or more swellable thermoplastic polyurethane (TPU) resins.

21. The process according to claim 19, wherein the thermoplastic polyurethane (TPU) membrane further includes a bituminous or bentonite coating.

22. The process according to claim 19, wherein the thermoplastic polyurethane (TPU) membrane has a thickness of from about 0.152 mm (0.006 in.) to about 0.381 mm (0.015 in.).

23. The process according to claim 19, wherein the thermoplastic polyurethane (TPU) membrane has a thickness of about 0.152 mm (0.006 in.).

24. The process according to claim 19, wherein the thermoplastic polyurethane (TPU) membrane further includes an adhesive backing.

25. The process according to claim 19, wherein the thermoplastic polyurethane (TPU) membrane further includes a layer of fleece.

26. The process according to claim 19, wherein the thermoplastic polyurethane (TPU) membrane is self-sealing.

27. The process according to claim 19, wherein the belowgrade surface is one of concrete and masonry.

28. The process according to claim 19, wherein the structure is one of a building foundation, a building basement, a reservoir, an ornamental pool, a pond, a plaza deck, a parking deck, a walkway, a tunnel, an earthen shelter, a bridge abutment, a retaining wall, a landfill, a chemical canal and a water canal.

29. The process according to claim 19, wherein the thermoplastic polyurethane (TPU) membrane is capable of withstanding a hydrostatic pressure of at least about 276 kPa (40 psi).

30. The process according to claim 19, wherein the thermoplastic polyurethane (TPU) membrane is capable of withstanding a hydrostatic pressure of at least about 621 kPa (90 psi).

31. One of a building foundation, building basement, reservoir, ornamental pool, pond, plaza deck, parking deck, walkway, tunnel, earthen shelter, bridge abutment, retaining wall, landfill, chemical canal and water canal having adhered to a belowgrade surface thereof a thermoplastic polyurethane (TPU) membrane having a thickness of from about 0.0508 mm (0.002 in.) to about 0.457 mm (0.018 in.) and capable of withstanding a hydrostatic pressure of at least about 138 kPa (20 psi).
